(19) United States
(12) Patent Application Publication
(10) Pub. No.: US 2009/0153078 A1
(43) Pub. Date: Jun. 18, 2009

(54) LED ARRAY CIRCUIT

(76) Inventor: Vilmar Lin, Jhubei City (TW)

Correspondence Address: Anthony R. Barkume, 20 Gateway Lane, Manorville, NY, 11949, US

(21) Appl. No.: 12/140,362

(22) Filed: Jun. 17, 2008

(30) Foreign Application Priority Data
Dec. 14, 2007 (TW) 096221460

(51) Int. Cl. H05B 37/00

(52) U.S. Cl. 315/312

(57) ABSTRACT

The present invention relates to a LED array circuit having a plurality of LED units and each one of the LED units comprises a horizontal scanning line; a vertical scanning line; a first LED, which connects with the horizontal scanning line by the positive end and connects with the vertical scanning line by the negative end; and a second LED, which connects with the vertical scanning line by the positive end and connects with the horizontal scanning line by the negative end; wherein the LED units is aligned each other by the connected horizontal scanning line and vertical scanning line to form the LED array circuit.

### FIELD OF THE INVENTION

The present invention relates to a LED array circuit, especially for the LED array circuit connecting and controlling two LEDs between a pair of horizontal scanning line and vertical scanning line.

### BACKGROUND OF THE INVENTION

FIG. 1 shows the array structure diagram of the traditional LEDs, which contains LED 11, LED 12, the first vertical scanning line 13, LED 14, LED 15, the second vertical scanning line 16, the first horizontal scanning line 17, and the second horizontal scanning line 18.

The traditional 2×2 LED array, such as the one shown in FIG. 1, contains one set of horizontal scanning lines and one set of vertical scanning lines. The horizontal scanning line set contains two horizontal scanning lines: the first horizontal scanning line 17 and the second horizontal scanning line 18. The vertical scanning line set contains two vertical scanning lines: the first vertical scanning line 13 and the second vertical scanning line 16. There can be connected with each one of LED 11, 12, 14, and 15 between every pair of horizontal scanning lines 17, 18, and vertical scanning lines 13, 16, respectively. Therefore, the structure with two horizontal scanning lines 17, 18 and two vertical scanning lines 13, 16 is able to drive four LED 11, 12, 14, and 15, to be a 2×2 LED array.

The traditional 2×2 LED array outputs logic high voltage by scanning on horizontal scanning lines 17, 18 of the horizontal scanning line set, and outputs logic low voltage on the vertical scanning lines which are connected with the drived LED, to light on the LEDs. Any one of the LEDs will not turn on if the corresponding vertical scanning line outputs logic high voltage. For example, if LED 11 is going to turn on, the first vertical scanning line 13 outputs logic low voltage when we scan the first horizontal scanning line 17 (the positive end of LED 11 connects with the logic high voltage output of the first horizontal scanning line 17, and the negative end of LED 11 connects with the logic low voltage output of the first vertical scanning line 13, and this LED 11 will be turned on). On the other hand, if LED 15 will not turn on, the second vertical scanning line 16 outputs logic high voltage when we scan the second horizontal scanning line 18 (the positive end of LED 15 connects with the logic high voltage output of the second horizontal scanning line 18, and the negative end of LED 15 connects with the logic high voltage output of the second vertical scanning line 16, and this LED 15 will not turn on).

There are several disadvantages in the prior technologies:

In the traditional LED array circuit, there is only one LED can be connected and controlled between every pair of horizontal and vertical scanning lines, but no more any LED be arranged, so the size can't be reduced.

Therefore, how to drive more LEDs at the same time in the LED array circuit to improve above disadvantages is the major topic of the present invention.

### SUMMARY OF THE INVENTION

An objective of the present invention is to provide a new and advanced LED array circuit, which revises the positive ends and negative ends of the two connected LEDs between every pair of horizontal scanning line and vertical scanning line, and output high level and logic low voltage alternately on the horizontal scanning lines and vertical scanning lines to drive more LEDs simultaneously on the LED array circuit.

According to the invention, a LED array circuit has a plurality of LED units and each one of the LED units comprises:

a horizontal scanning line;

a vertical scanning line;

a first LED, which connects with the horizontal scanning line by the positive end and connects with the vertical scanning line by the negative end;

a second LED, which connects with the vertical scanning line by the positive end and connects with the horizontal scanning line by the negative end;

wherein the LED units is aligned each other by the connected horizontal scanning line and vertical scanning line to form the LED array circuit.

In accordance with one aspect of the present invention, the first LED is scanned on by providing a logic high voltage on the horizontal scanning line and providing a logic low voltage on the vertical scanning line.

In accordance with one aspect of the present invention, the second LED is scanned by providing a logic low voltage on the horizontal scanning line and providing a logic high voltage on the vertical scanning line.

The present invention may best be understood through the following description with reference to the accompanying drawings, in which:

### BRIEF DESCRIPTION OF THE DRAWINGS

FIG. 1 shows the architecture diagram of the LED array circuit using the traditional technology;

FIG. 2 shows the architecture diagram of the LED array circuit according to the embodiment of the present invention.

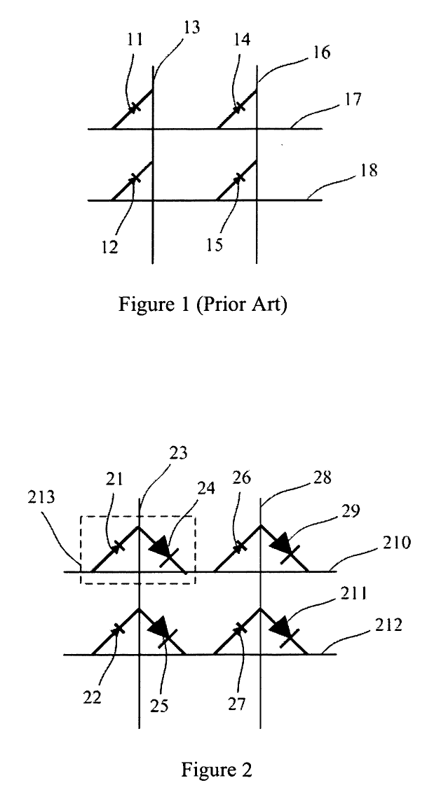

### DETAILED DESCRIPTION OF THE INVENTION

FIG. 2 shows the embodiment diagram of the LED array circuit according to the present invention, which contains the first LED 21, the first LED 22, the first vertical scanning line 23, the second LED 24, the second LED 25, the first LED set 26, the first LED 27, the second vertical scanning line 28, the second LED 29, the first horizontal scanning line 210, the second LED 211, the second horizontal scanning line 212, and LED unit 213.

In accordance with the executing embodiment to the present invention of LED array circuit, as shown in FIG. 2, there is a 2×2 array circuit structure contains four LED units 213 with one set of horizontal scanning lines and one set of vertical scanning lines. The set of horizontal scanning lines contains two horizontal scanning lines for the first horizontal scanning line 210 and the second horizontal scanning line 212. The set of vertical scanning lines also contains two vertical scanning lines for the first vertical scanning line 23 and the second vertical scanning line 28. Different from the traditional technology, the LED array circuit according to the present invention is able to electrical connect with two LED 21, 22, 24, 25, 26, 27, 29, and 211 between every pair of horizontal scanning lines 210, 212 and vertical scanning lines 23, 28, respectively. The positive ends of the first LEDs 21, 22, 26, and 27 connect with the horizontal scanning lines 2 10 and 212, and the negative ends connect with the vertical scanning lines 23 and 28. The positive ends of the second LEDs 24, 25, 29, and 211 connect with the vertical scanning lines 23 and 28, the negative ends connect with the horizontal scanning lines 210 and 212. Therefore, this LED array circuit structure contains two horizontal scanning lines 210, 212, and two vertical scanning lines 23, 28, is able to drive eight LEDs 21, 22, 24, 25, 26, 27, 29, and 211, totally.

In accordance with the executing embodiment to the present invention of LED array circuit, the driven solution of the first LEDs 21, 22, 26, and 27 is the same with the traditional technology (output logic high voltage on the horizontal scanning lines 210, 212 and output logic low voltage on the vertical scanning lines 23, 28). However, for the second LEDs 24, 25, 29, and 211, the present invention uses another special driving solution: after the first LEDs 21, 22, 26, and 27 being driven completely, making the horizontal scanning lines 210, 212 output logic low voltage, and making the vertical scanning lines 23 and 28 output logic high voltage, to scan the second LEDs 24, 25, 29, and 211. This driving solution can turn off the second LEDs 24, 25, 29, and 211 when the first LEDs 21, 22, 26, and 27 are scanned; and also can turn off the first LEDs 21, 22, 26, and 27 when the second LEDs 24, 25, 29, and 211 are scanned, to drive one more times number of LEDs under the same structure.

There are several advantages of the present invention:

In accordance with the executing embodiment to the present invention of LED array circuit, is able to drive two LEDs between every pair of horizontal scanning line and vertical scanning line, to make the same structure be able to drive one more times number of LEDs.

To sum up, the LED array circuit according to the present invention is able to electrical connect with two LEDs by inversed positive and negative connection between every pair of horizontal scanning line and vertical scanning line, and output high/low levels voltage on the horizontal scanning lines and vertical scanning lines alternately, to make the LED array circuit be able to drive one more times number of LEDs, with advanced and new technology. Any other modified design such as using different types of LEDs or increasing the scanning lines of the output ports, all belong to the protection field of the present invention once electrical connecting with two LEDs by inversed positive and negative connection between every pair of horizontal scanning line and vertical scanning line in the LED array circuit.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims to be accorded with the broadest interpretation so as to encompass all such modifications and similar solutions.

What is claimed is:

1. A LED array circuit having a plurality of LED units and each one of the LED units comprising:
a horizontal scanning line;
a vertical scanning line;
a first LED, which connects with the horizontal scanning line by the positive end and connects with the vertical scanning line by the negative end;
a second LED, which connects with the vertical scanning line by the positive end and connects with the horizontal scanning line by the negative end;
wherein the LED units is aligned each other by the connected horizontal scanning line and vertical scanning line to form the LED array circuit.

2. The LED array circuit according to claim 1, wherein the first LED is scanned by providing a logic high voltage on the horizontal scanning line and providing a logic low voltage on the vertical scanning line.

3. The LED array circuit according to claim 1 wherein the second LED is scanned by providing a logic low voltage on the horizontal scanning line and providing a logic high voltage on the vertical scanning line.
